(19) United States
(12) Patent Application Publication
(10) Pub. No.: US 2023/0115071 A1
(43) Pub. Date: Apr. 13, 2023

(54) METHOD OF VERIFYING TARGET PERSON, AND SERVER AND PROGRAM

(71) Applicant: OPENIT INC., Seoul (KR)

(72) Inventor: Min Young KIM, Seoul (KR)

(73) Assignee: OPENIT INC., Seoul (KR)

(21) Appl. No.: 17/520,148

(22) Filed: Nov. 5, 2021

(30) Foreign Application Priority Data
Oct. 8, 2021 (KR) 10-2021-0134241

(51) Int. Cl. G06K 9/00

(52) U.S. Cl. CPC G06K 9/00369; G06K 9/00348; G06K 9/00382; G06K 9/00885

(57) ABSTRACT

Provided are a method of verifying a target person, the method comprises collecting non-identifying personal data for a target person, determining a classification type for each of a plurality of classification criteria from the collected non-identifying personal data and performing verification based on a result of comparing the determined classification type for each of the plurality of classification criteria with a reference type for each of the plurality of classification criteria.

### BACKGROUND

### 1. Field

The disclosure relates to a method of verifying a target person, and a server and a program using the same, and more particularly, to a method of verifying a target person by using a classification type corresponding to each of a plurality of classification criteria in non-identifying personal data collected from the target person, and a server and a program using the same.

### 2. Description of the Related Art

Biometric authentication is a technology that verifies the identity of a person using physical or behavioral characteristics and grants the person access to devices, services, or spaces with restricted access rights. Biometric data such as fingerprint, face, or voice is mainly used for biometric authentication, and a characteristic or pattern unique to each person in the biometric data is utilized for biometric authentication.

However, there is a case where continuous authentication and verification management are required even for users who have completed biometric authentication, and in this case, performing biometric authentication again significantly reduces the economic efficiency, efficiency, or user convenience of facility construction.

### SUMMARY

Provided are a method of verifying a target person by using a classification type corresponding to each of a plurality of classification criteria in non-identifying personal data collected from the target person, and a server and a program using the same.

According to an aspect of an embodiment, a method of verifying a target person may comprise collecting non-identifying personal data for a target person, determining a classification type for each of a plurality of classification criteria from the collected non-identifying personal data and performing verification based on a result of comparing the determined classification type for each of the plurality of classification criteria with a reference type for each of the plurality of classification criteria.

According to an aspect of an embodiment, the non-identifying personal data may be data that cannot directly identify the target person, but indicates personal characteristics of the target person.

According to an aspect of an embodiment, each of the classification criteria may be a criterion for classifying the non-identifying personal data according to a data type of the non-identifying personal data.

According to an aspect of an embodiment, each of the classification criteria may comprise at least one of the type of clothes, the color of clothes, the hairstyle, the beard shape, the type of accessories being worn, and whether or not glasses are worn of the target person.

According to an aspect of an embodiment, the classification type may be classified into groups having a common attribute for each of the plurality of classification criteria.

According to an aspect of an embodiment, the collected non-identifying personal data may comprise data corresponding to the plurality of classification criteria.

According to an aspect of an embodiment, the performing of verification may comprise applying a weight to each of the plurality of classification criteria included in the collected non-identifying personal data, and performing verification by applying the weight to a result of comparing the classification type for each of the plurality of classification criteria with the reference type for each of the plurality of classification criteria.

According to an aspect of an embodiment, the method may further comprise collecting non-identifying personal data of the target person in a biometric authentication process initially performed for the target person and determining the reference type for each of the plurality of classification criteria from the collected non-identifying personal data and storing the reference type.

According to an aspect of an embodiment, the reference type for each of the plurality of classification criteria may be a classification type corresponding to a situation determined based on location information and time information of the target person.

According to an aspect of an embodiment, the method may further comprise determining an abnormal situation based on collected data collected from a portable terminal possessed by the target person, wherein the verification is performed only when an abnormal situation occurs according to a result of the determining.

According to an aspect of an embodiment, the collecting of non-identifying personal data for the target person may comprise when the abnormal situation occurs, collecting non-identifying personal data of the target person through a non-identifying personal data collection device that monitors an area where the portable terminal in which an abnormal situation occurs is located.

According to an aspect of an embodiment, the collected data may be collected from the portable terminal through a gateway.

According to an aspect of an embodiment, the collected data may comprise location data or motion sensing data of the portable terminal.

According to another aspect of an embodiment, a verification server may comprise a classification type determiner configured to collect non-identifying personal data for a target person and determine a classification type corresponding to each of a plurality of classification criteria for the collected non-identifying personal data and a verifier configured to perform verification based on a result of comparing the classification type corresponding to each of the plurality of determined classification criteria with a reference type.

### BRIEF DESCRIPTION OF THE DRAWINGS

Embodiments of the disclosure will be more clearly understood from the following detailed description taken in conjunction with the accompanying drawings in which:

FIG. 1 is a conceptual diagram of an authentication/verification system according to an embodiment;

FIG. 2 is a conceptual diagram of an authentication and verification structure including a verification process according to an embodiment;

FIG. 3 is a block diagram of a non-identifying personal data collection device shown in FIG. 1, according to an embodiment;

FIG. 4 is a block diagram of a verification server shown in FIG. 1, according to an embodiment; and

FIG. 5 is a flowchart illustrating a method of verifying a target person according to an embodiment.

### DETAILED DESCRIPTION

The inventive concept may be variously modified and have various embodiments, so that specific embodiments will be illustrated in the drawings and described in the detailed description. However, this does not limit the inventive concept to specific embodiments, and it should be understood that the inventive concept covers all the modifications, equivalents and replacements included within the idea and technical scope of the inventive concept.

In describing the inventive concept, in the following description, a detailed explanation of known related technologies may be omitted to avoid unnecessarily obscuring the subject matter of the present disclosure. In addition, numeral figures (e.g., 1, 2, and the like) used during describing the specification are just identification symbols for distinguishing one element from another element.

Further, in the specification, if it is described that one component is “connected” or “accesses” the other component, it is understood that the one component may be directly connected to or may directly access the other component but unless explicitly described to the contrary, another component may be “connected” or “access” between the components.

In addition, terms including “unit,” “er,” “or,” “module,” and the like disclosed in the specification mean a unit that processes at least one function or operation and this may be implemented by hardware or software such as a processor, a micro processor, a micro controller, a central processing unit (CPU), a graphics processing unit (GPU), an accelerated Processing unit (APU), a digital signal processor (DSP), an application specific integrated circuit (ASIC), and a field programmable gate array (FPGA) or a combination of hardware and software. Furthermore, the terms may be implemented in a form coupled to a memory that stores data necessary for processing at least one function or operation.

Moreover, it is intended to clarify that components in the specification are distinguished in terms of primary functions of the components. That is, two or more components to be described below may be provided to be combined to one component or one component may be provided to be divided into two or more components for each more subdivided function. In addition, each of the respective components to be described below may additionally perform some or all functions among functions which other components take charge of in addition to a primary function which each component takes charge of and some functions among the primary functions which the respective components take charge of are exclusively charged by other components to be performed, of course.

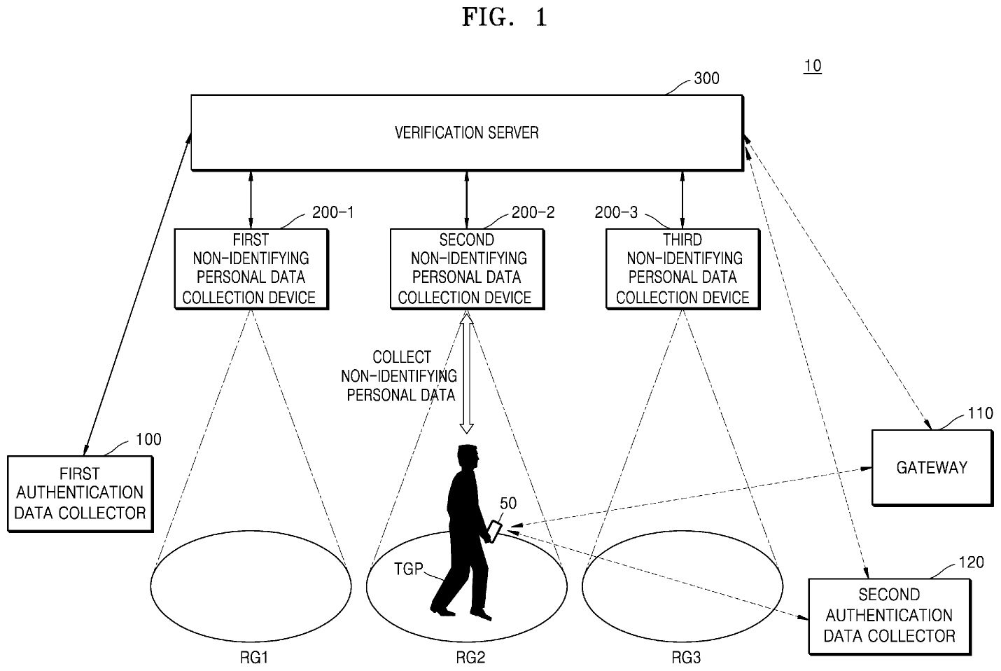

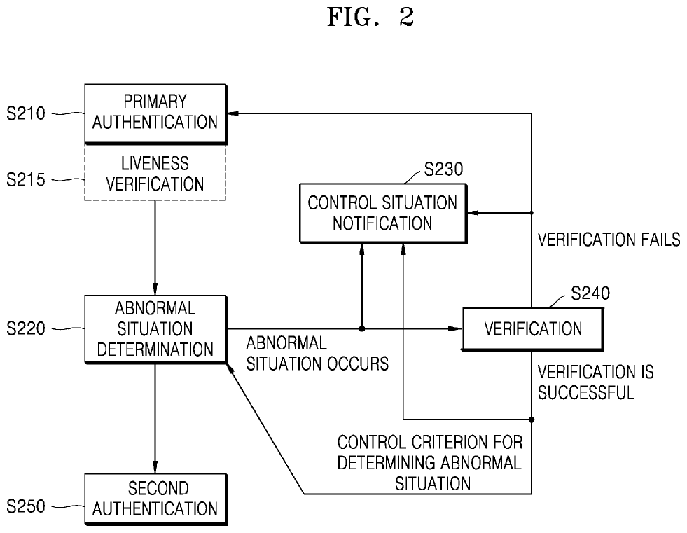

FIG. 1 is a conceptual diagram of an authentication/verification system according to an embodiment. FIG. 2 is a conceptual diagram of an authentication and verification structure including a verification process according to an embodiment.

Referring to FIG. 1, an authentication/verification system 10 according to an embodiment may include a first authentication data collector 100, a gateway 110, a second authentication data collector 120, a plurality of non-identifying personal data collection devices 200-1 to 200-3, and a verification server 300.

In this specification, the terms of “authentication” and “verification” are used separately depending on the level of confirming a target person. However, in some cases, both “authentication” and “verification” may be used with the same meaning in that both are procedures for identifying a target person, and in this case, the two terms may be used interchangeably. A target person TGP of FIG. 1 may be both a target person and an authentication target, and the verification server 300 of FIG. 1 may perform both a verification process and an authentication process.

Referring to FIGS. 1 and 2 together, the authentication/verification system 10 may include a two-step authentication procedure consisting of primary authentication operation (S210) and secondary authentication operation (S250).

According to an embodiment, the primary authentication operation (S210) is performed when the target person TGP first enters access-restricted facilities (or when initially accessing access-restricted services), and the secondary authentication operation (S250) may be performed when the target person TGP enters a space requiring a separate authentication procedure in the access-restricted facilities or when using a service requiring additional authentication in the access-restricted facilities (or when accessing services with additional access restrictions from among the access-restricted services). In addition, various modifications are possible for examples in which the primary authentication operation (S210) and the secondary authentication operation (S250) are used.

Authentication data to be used in the primary authentication operation (S210) may be collected by the first authentication data collector 100 and transmitted to the verification server 300.

According to an embodiment, the primary authentication operation (S210) may be performed in a self-conscious authentication method in which the target person TGP needs to perform a separate action for authentication.

According to an embodiment, the primary authentication operation (S210) may be performed in a biometric authentication method.

According to an embodiment, when the primary authentication operation (S210) is performed in the biometric authentication method, liveness verification operation (S215) for confirming whether biometric data collected for biometric authentication is not due to biometric mimicking may be further included.

According to an embodiment, in the primary authentication operation (S210), at least two of biometric information of the target person TGP, ID of the target person TGP, and identification information (e.g., a Media Access Control (MAC) address, International Mobile Equipment Identity (IMEI), etc.) of a portable terminal 50 possessed by the target person TGP may be mapped to each other and stored in the verification server 300.

Authentication data to be used in the second authentication operation (S250) may be collected by the second authentication data collector 120 and transmitted to the verification server 300.

According to an embodiment, the secondary authentication operation (S250) may be performed in an insensitive authentication method that does not require the target person TGP to perform a separate action for authentication.

According to an embodiment, the secondary authentication operation (S250) may be performed in the form of authenticating the portable terminal 50 through identification information (e.g., an MAC address, IMEI, etc.) of the portable terminal 50 possessed by the target person TGP.

According to another embodiment, in the secondary authentication operation (S250), authentication may be performed using a behavior pattern of the target person TGP based on sensing data collected through the portable terminal 50 possessed by the target person TGP.

According to another embodiment, the secondary authentication operation (S250) may be performed by collecting an image of the target person TGP, and using biometric information or a behavior pattern of the target person TGP determined from the collected image.

Between the primary authentication operation (S210) and the secondary authentication operation (S250), in operation S220, it is determined continuously or periodically whether an abnormal situation occurs in the target person TGP or the portable terminal 50 possessed by the target person TGP, and when an abnormal situation occurs, verification operation (S240) may be performed.

The abnormal situation may broadly mean a case in which a problem occurs in the operation of the portable terminal 50 that the target person TGP initially possesses in the primary authentication operation (S210), and thus there is a failure in the secondary authentication operation (S250) using the portable terminal 50, or a case in which the portable terminal 50 may be possessed and abused by someone other than the target person TGP.

According to an embodiment, the abnormal situation may correspond to a case in which authentication authority granted to the target person TGP in the process of the primary authentication operation (S210) has expired, or is out of the scope of the granted authentication authority.

When the verification fails in the verification operation (S240), authentication procedure may return to the primary authentication operation (S210). In this case, the target person TGP needs to perform the primary authentication operation (S210) again, and needs to succeed in authentication in the primary authentication operation (S210) to be able to enter the access-restricted facilities (or the access-restricted services) again.

When the verification is successful in the verification operation (S240), procedure may return to the abnormal situation determination operation (S220). In this case, the target person TGP does not need to newly perform the primary authentication operation (S210). According to an embodiment, even if the verification is successful, a determination criterion in the abnormal situation determination operation (S220) may be adjusted. For example, a criterion for determining an abnormal situation may be lowered according to the number of times the verification operation (S240) is performed, and in this case, the number of cases that may be determined as an abnormal state may be relatively increased compared to a case where the verification operation (S240) is not performed.

When an abnormal situation occurs in the abnormal situation determination operation (S220), or when the verification fails or the verification is successful in the verification operation (S240), control situation notification operation (S230) may be performed for the corresponding situation. In this case, at least one of the fact that an abnormal situation occurs, the type of abnormal situation, the location where an abnormal situation occurs, identification information of a portable terminal in which an abnormal situation occurs, and identification information of a target person having the portable terminal may be transmitted in the form of a notification to a central control room (not shown) that manages the authentication/verification system 10.

Returning to FIG. 1, the target person TGP may carry the portable terminal 50 and enter and exit a space (or service) managed by the authentication/verification system 10.

The portable terminal 50 is portable by the target person TGP, and may broadly mean a terminal capable of wireless communication.

According to an embodiment, the portable terminal 50 may be implemented as a wearable device that can be carried in a form worn by the target person TGP.

According to an embodiment, the portable terminal 50 may collect location data and motion sensing data of the target person TGP.

According to another embodiment, when the portable terminal 50 is implemented as a wearable device, the portable terminal 50 may include a sensing device capable of sensing a state of contact with the target person TGP.

According to an embodiment, the portable terminal 50 may be implemented as a beacon and transmit a Bluetooth signal to the gateway 110 located in the authentication/verification system 10, and location data of the portable terminal 50 may be collected through the location of at least one gateway that has received the Bluetooth signal transmitted from the portable terminal 50.

According to an embodiment, the portable terminal 50 may include a sensor for collecting motion sensing data (e.g., accelerometer, gyro sensor, etc.).

The first authentication data collector 100 may collect authentication data to be used for authentication in the primary authentication operation (S210) from the target person TGP and transmit the authentication data to the verification server 300.

According to an embodiment, when the primary authentication operation (S210) is performed by biometric authentication, the first authentication data collector 100 may collect biometric data (e.g., face, iris, retina, voice, fingerprint, hand shape, vein, handwriting, etc.) from the target person TGP and transmit the collected biometric data to the verification server 300.

According to an embodiment, the first authentication data collector 100 may collect identification information of the portable terminal 50 possessed by the target person TGP, the ID of the target person TGP, and the like, in addition to the authentication data to be used for authentication in the primary authentication operation (S210).

The verification server 300 may perform the primary authentication operation (S210) using authentication data transmitted from the first authentication data collector 100.

The gateway 110 may periodically collect location data (it may be a Bluetooth signal when the portable terminal 50 uses beacon-type positioning) and motion sensing data from the portable terminal 50 of the target person TGP who has completed the primary authentication operation (S210). Although FIG. 1 illustrates a case in which one gateway 110 receives location data from the portable terminal 50 for convenience of explanation, a plurality of gateways may obtain location information of the portable terminal 50 by receiving location data (it may be a Bluetooth signal when the portable terminal 50 uses beacon-type positioning) from the portable terminal 50.

The gateway 110 may transmit the location data and the motion sensing data received from the portable terminal 50 to the verification server 300. The verification server 300 may determine whether an abnormal situation occurs and the type of abnormal situation based on the received location data and motion sensing data.

By performing the abnormal situation determination operation (S220) by the verification server 300, when it is determined that an abnormal situation occurs, the verification operation (S240) may be performed.

The verification server 300 may collect non-identifying personal data of the target person TGP through a non-identifying personal data collection device 200-2 that monitors an area (e.g., RG2) where the portable terminal 50 in which an abnormal situation occurs is located.

Each of the plurality of non-identifying personal data collection devices 200-1 to 200-3 may collect non-identifying personal data continuously, periodically, or on an event basis from the target person TGP who has completed the primary authentication operation (S210). For example, in a case of collecting non-identifying personal data based on an event, when an abnormal situation occurs, under the control of the verification server 300, only a non-identifying personal data collection device that monitors an area where the portable terminal 50, which is determined to be in an abnormal situation, is located, may selectively operate.

As used herein, the term “non-identifying personal data” may refer to data that cannot directly identify an authentication target (target person), but indicates personal characteristics of the authentication target (target person).

According to an embodiment, the non-identifying personal data may include at least one of the type of clothes, the color of clothes, the hairstyle, the beard shape, the type of accessories being worn, and whether or not glasses are worn of the authentication target (target person).

According to an embodiment, each of the plurality of non-identifying personal data collection devices 200-1 to 200-3 may monitor areas RG1 to RG3 respectively allocated to the plurality of non-identifying personal data collection devices 200-1 to 200-3.

For example, when the target person TGP in which an abnormal situation occurs is in the first area RG1, the first non-identifying personal data collection device 200-1 may collect non-identifying personal data of the target person TGP, when the target person TGP in which an abnormal situation occurs is in the second area RG2, the second non-identifying personal data collection device 200-2 may collect non-identifying personal data of the target person TGP, and when the target person TGP in which an abnormal situation occurs is in the third area RG3, the third non-identifying personal data collection device 200-3 may collect non-identifying personal data of the target person TGP.

According to an embodiment, each of the plurality of non-identifying personal data collection devices 200-1 to 200-3 may directly extract non-identifying personal data from a video (or image) collected from the target person TGP and then transmit the extracted non-identifying personal data to the verification server 300.

According to another embodiment, each of the plurality of non-identifying personal data collection devices 200-1 to 200-3 may transmit the video (or image) collected from the target person TGP to the verification server 300, and the verification server 300 may extract non-identifying personal data from the received video (or image).

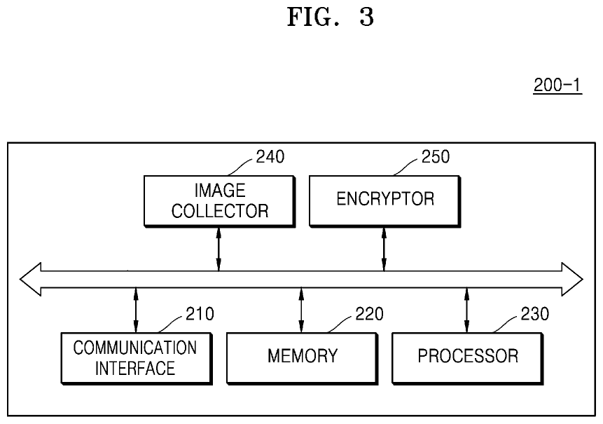

A detailed configuration and operation of each of the plurality of non-identifying personal data collection devices 200-1 to 200-3 will be described later with reference to FIG. 3.

The verification server 300 may perform a verification process using non-identifying personal data collected by at least one of the plurality of non-identifying personal data collection devices 200-1 to 200-3.

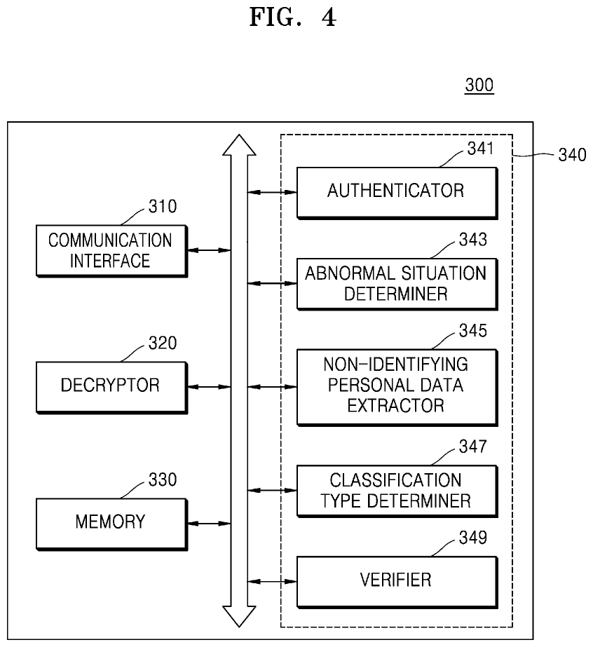

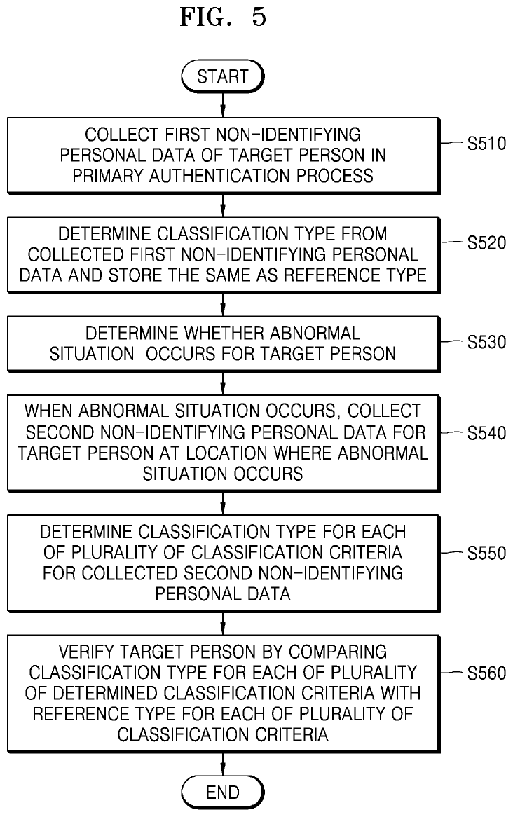

A detailed configuration and verification process of the verification server 300 will be described later with reference to FIGS. 4 and 5.

FIG. 1 shows three non-identifying personal data collection devices 200-1 to 200-3 for convenience of explanation, but the number of non-identifying personal data collection devices may vary, and a plurality of gateways 110 may also be configured for each space in the authentication/verification system 10 according to the communication coverage of the portable terminal 50.

FIG. 3 is a block diagram of the non-identifying personal data collection device shown in FIG. 1, according to an embodiment.

Referring to FIGS. 1 to 3, FIG. 3 shows a block diagram of any one (200-1) of the plurality of non-identifying personal data collection devices 200-1 to 200-3 for convenience of explanation, but the other non-identifying personal data collection devices 200-2 to 200-3 may also include the same configuration and operate in the same manner.

The non-identifying personal data collection device 200-1 may include a communication interface 210, a memory 220, a processor 230, an image collector 240, and an encryptor 250.

The communication interface 210 may interface communication between the verification server 300 and the non-identifying personal data collection device 200-1, and may process data or signals transmitted/received during the interfacing process.

The memory 220 may temporarily or permanently store data required to process the processor 230, data generated during or after the processing of the processor 230, or data collected by the image collector 240.

The processor 230 may perform general operations and data processing performed in the non-identifying personal data collection device 200-1.

According to an embodiment, the processor 230 may include the encryptor 250 in the form of a module.

The image collector 240 may collect a video (or image) of an area (e.g., RG1) covered by a corresponding non-identifying personal data collection device (e.g., 200-1).

The encryptor 250 may encrypt the video (or image) collected by the image collector 240 and manage the encrypted video (or image).

According to an embodiment, the encryptor 250 may encrypt biometric information in various methods such as a public key cryptography method (e.g., Fast Identity Online (FIDO) standard), and the technical scope of the disclosure is not limited by the encryption method of the encryptor 250.

According to an embodiment, when non-identifying personal data is extracted from the non-identifying personal data collection device 200-1, a configuration for extracting non-identifying personal data may be further included. At this time, the non-identifying personal data collection device 200-1 may extract non-identifying personal data by removing a portion that allows a specific person to be directly identified from the video or image collected by the image collector 240 or by processing a special effect (e.g., blur, mosaic processing, etc.) on the portion that allows a specific person to be directly identified.

FIG. 4 is a block diagram of the verification server 300 shown in FIG. 1, according to an embodiment.

Referring to FIGS. 1 to 4, the verification server 300 may include a communication interface 310, a decryptor 320, a memory 330, and a processor 340.

The communication interface 310 may interface communication between the verification server 300 and the first authentication data collector 100, communication between the verification server 300 and the non-identifying personal data collection devices 200-1 to 200-3, communication between the verification server 300 and the gateway 110, and communication between the verification server 300 and the second authentication data collector 120, and may process data or signals transmitted and received during the interfacing process.

The decryptor 320 may decrypt encrypted primary authentication data collected by the first authentication data collector 100 or encrypted secondary authentication data collected by the second authentication data collector 120. In addition, the decryptor 320 may decrypt encrypted video (or image) data or encrypted non-identifying personal data collected by the plurality of non-identifying personal data collection devices 200-1 to 200-3.

The memory 330 may temporarily or permanently store data required to process the processor 340, data generated during or after the processing of the processor 340, or the like.

The processor 340 may include an authenticator 341, an abnormal situation determiner 343, a non-identifying personal data extractor 345, a classification type determiner 347, and a verifier 349.

The authenticator 341 may perform the primary authentication operation (S210) using the authentication data collected by the first authentication data collector 100, and the second authentication operation (S250) using the authentication data collected by the second authentication data collector 120.

The abnormal situation determiner 343 may determine whether an abnormal situation occurs in the target person TGP or the portable terminal 50 through information (location data or motion sensing data of the portable terminal 50, etc.) collected from the portable terminal 50 of the target person TGP. For example, when it is determined that the location of the portable terminal 50 stays in one place for a long time and there is no movement, or when it is determined that the location of the portable terminal 50 shows an abnormal movement pattern (e.g., abnormally abrupt movements, etc.), it may be determined that an abnormal situation occurs.

According to an embodiment, the abnormal situation determiner 343 may classify and determine the types of abnormal situations. For example, the types of abnormal situations may be divided into various types such as non-wearing, damage, loss, or theft of the portable terminal 50.

The non-identifying personal data extractor 345 may extract non-identifying personal data from videos (or images) collected by the plurality of non-identifying personal data collection devices 200-1 to 200-3.

According to an embodiment, the non-identifying personal data extractor 345 may extract non-identifying personal data by removing a portion that allows a specific person to be directly identified from a video or image collected by each of the plurality of non-identifying personal data collection devices 200-1 to 200-3 or by processing a special effect (e.g., blur, mosaic processing, etc.) on the portion that allows a specific person to be directly identified.

According to another embodiment, when non-identifying personal data is transmitted to the verification server 300 in the form extracted by each of the plurality of non-identifying personal data collection devices 200-1 to 200-3, the verification server 300 may not include the non-identifying personal data extractor 345.

The classification type determiner 347 may determine a classification type corresponding to each of a plurality of classification criteria for the non-identifying personal data collected by the non-identifying personal data collection devices 200-1 to 200-3.

Each of the plurality of classification criteria may be a criterion for classifying non-identifying personal data according to a data type of the non-identifying personal data. For example, the classification criteria may be the type of clothes, the color of clothes, the hairstyle, the beard shape, the type of accessories being worn, or whether or not glasses are worn of the target person TGP.

According to an embodiment, collected non-identifying personal data may include data corresponding to the plurality of classification criteria.

The classification type may be classified into groups having a common attribute among the plurality of classification criteria. For example, within a classification criterion of “type of clothing”, long-sleeved/short-sleeved, shirt/t-shirt, one-piece/two-piece, etc. may be configured as classification types according to common attributes. For example, within a classification criterion of “hairstyle”, black hair/dyed (by color), long/short hair, parted (left, middle, right), straight hair/curly, etc. may be configured as classification types according to common attributes.

The verifier 349 may perform verification based on a result of comparing the classification type corresponding to each of the plurality of determined classification criteria with a reference type.

For example, it may be determined that the verification is successful when a reference type for each of a plurality of classification criteria initially collected by the target person TGP is a “long-sleeved shirt” in the “type of clothing” classification criterion and “left parted black hair” in the “hairstyle” classification criterion. In addition, it may be determined that the verification is successful when a reference type for each classification criterion of non-identifying personal data collected by the non-identifying personal data collection device 200-1 to 200-3 is a “long-sleeved shirt” in the “type of clothing” classification criterion and “left parted black hair” in the “hairstyle” classification criterion.

According to an embodiment, the verifier 349 may apply a weight to each of a plurality of classification criteria, and may perform verification by applying the weight to a result of comparing a classification type for each of the plurality of classification criteria with a reference type.

For example, it is assumed that a classification criterion has a weight of 4:4:2 for the type of clothing, hairstyle, and type of accessory being worn, and a criterion value of a matching rate for determining whether the verification is successful is 0.7. In this case, when a classification type for the type of clothing and hairstyle matches a reference type, but a classification type for the type of accessory being worn does not match the reference type, it can be determined that verification is successful because the matching rate is 0.8, exceeding the criterion value of 0.7.

According to an embodiment, the weight may be determined according to the variability of corresponding classification criteria. In this case, a relatively low weight may be set for a classification criterion with a high possibility of variation, and a relatively high weight may be set for a classification criterion with a low possibility of variation.

FIG. 5 is a flowchart illustrating a method of verifying a target person according to an embodiment.

Referring to FIGS. 1 to 5, in the method of verifying a target person according to an embodiment, in operation S510, first non-identifying personal data of the target person TGP may be collected in an initial primary authentication process (e.g., operation S210).

According to an embodiment, the primary authentication (e.g., operation S210) may be biometric authentication. In this case, the first authentication data collector 100 may collect biometric data from the target person TGP and transmit the biometric data to the verification server 300. The verification server 300 may collect the first non-identifying personal data from the received biometric data. At this time, the non-identifying personal data extractor 345 of the verification server 300 may collect non-identifying personal data by removing a portion that allows a specific person to be directly identified from the biometric data (e.g., a collected video or image) or by processing a special effect (e.g., blur, mosaic processing, etc.) on the portion that allows a specific person to be directly identified.

In the method of verifying a target person according to an embodiment, in operation S520, a classification type for each of a plurality of classification criteria may be determined from the first non-identifying personal data collected in operation S510 and stored as a reference type.

According to an embodiment, the classification type determiner 347 of the verification server 300 may determine or extract a classification type for each of the plurality of classification criteria from the first non-identifying personal data, and may store the classification type as a reference type.

According to another embodiment, the reference type may be set to a classification type corresponding to a situation determined based on location information and time information of the target person TGP. For example, the location of the target person TGP is an operating room, and the time information may be determined as a surgical condition when it is a time for an operation to be performed in the operating room. In this case, the reference type may be determined and stored as a type of “surgical clothes” with respect to a type suitable for a surgical situation, for example, a classification criterion of “type of clothing”.

In the method of verifying a target person according to an embodiment, in operation S530, it may be determined whether an abnormal situation occurs for the target person TGP.

According to an embodiment, the verification server 300 may determine whether an abnormal situation occurs for the target person TGP who has completed the primary authentication operation (S210).

The abnormal situation may broadly mean a case in which a problem occurs in the operation of the portable terminal 50 that the target person TGP initially possesses in the primary authentication operation (S210), or a case in which the portable terminal 50 may be abused by someone other than the target person TGP.

According to an embodiment, the verification server 300 may determine whether an abnormal situation occurs and the type of the abnormal situation based on location data and motion sensing data collected through the gateway 110 from the portable terminal 50 possessed by the target person TGP.

In the method of verifying a target person according to an embodiment, in operation S540, when an abnormal situation occurs according to a result of the determination in operation S530, second non-identifying personal data for a target person may be collected at a location where the abnormal situation occurs.

According to an embodiment, the verification server 300 may use the location data collected from the portable terminal 50 to determine the location where the abnormal situation occurs, and may collect second non-identifying personal data of the target person TGP through a non-identifying personal data collection device (e.g., 200-2) that monitors an area (e.g., RG2) to which the location where the abnormal situation occurs belongs.

In the method of verifying a target person according to an embodiment, in operation S550, a classification type for each of a plurality of classification criteria may be determined from the second non-identifying personal data collected in operation S540.

The classification type determiner 347 of the verification server 300 may determine the classification type for each of the plurality of classification criteria from the second non-identifying personal data.

The method of verifying a target person according to an embodiment, in operation S560, may verify the target person TGP by comparing the classification type for each of the plurality of classification criteria determined in operation S540 with a reference type for each of the plurality of classification criteria stored in operation S520.

According to an embodiment, the verifier 349 of the verification server 300 may apply a weight to each of a plurality of classification criteria, and may perform verification by applying the weight to a result of comparing a classification type for each of the plurality of classification criteria with a reference type.

The method of verifying a target person according to an embodiment may be implemented as a program including program code for performing operations S510 to S560 and stored in a medium, and a processor may be combined with the medium to execute the program.

Methods and apparatuses according to an embodiment may use non-identifying personal data about a target person, which is relatively free to collect and store, to perform verification in an unconscious state that the target person is not aware of.

In addition, the methods and apparatuses according to an embodiment may improve the reliability of a verification process by using a combination of pieces of non-identifying personal data.

In addition, the methods and apparatuses according to an embodiment may minimize errors due to changes in some pieces of non-identifying personal data by applying a weight to the pieces of non-identifying personal data and using the weight? for verification.

In addition, the methods and apparatuses according to an embodiment may monitor whether an abnormal situation occurs for a target person who has completed the primary authentication, and may efficiently perform verification only on a target person in which an abnormal situation occurs.

While the disclosure has been particularly shown and described with reference to embodiments thereof, it will be understood that various changes in form and details may be made therein without departing from the spirit and scope of the following claims.

What is claimed is:

1. A method of verifying a target person, the method comprising:
collecting non-identifying personal data for a target person;
determining a classification type for each of a plurality of classification criteria from the collected non-identifying personal data; and
performing verification based on a result of comparing the determined classification type for each of the plurality of classification criteria with a reference type for each of the plurality of classification criteria.

2. The method of claim 1, wherein the non-identifying personal data is data that cannot directly identify the target person, but indicates personal characteristics of the target person.

3. The method of claim 1, wherein each of the classification criteria is a criterion for classifying the non-identifying personal data according to a data type of the non-identifying personal data.

4. The method of claim 3, wherein each of the classification criteria comprises at least one of the type of clothes, the color of clothes, the hairstyle, the beard shape, the type of accessories being worn, and whether or not glasses are worn of the target person.

5. The method of claim 1, wherein the classification type is classified into groups having a common attribute for each of the plurality of classification criteria.

6. The method of claim 1, wherein the collected non-identifying personal data comprises data corresponding to the plurality of classification criteria.

7. The method of claim 6, wherein the performing of verification comprises:
applying a weight to each of the plurality of classification criteria included in the collected non-identifying personal data, and performing verification by applying the weight to a result of comparing the classification type for each of the plurality of classification criteria with the reference type for each of the plurality of classification criteria.

8. The method of claim 1, further comprising:
collecting non-identifying personal data of the target person in a biometric authentication process initially performed for the target person; and
determining the reference type for each of the plurality of classification criteria from the collected non-identifying personal data and storing the reference type.

9. The method of claim 1, wherein the reference type for each of the plurality of classification criteria is a classification type corresponding to a situation determined based on location information and time information of the target person.

10. The method of claim 1, further comprising:
determining an abnormal situation based on collected data collected from a portable terminal possessed by the target person,
wherein the verification is performed only when an abnormal situation occurs according to a result of the determining.

11. The method of claim 10, wherein the collecting of non-identifying personal data for the target person comprises:
when the abnormal situation occurs, collecting non-identifying personal data of the target person through a non-identifying personal data collection device that monitors an area where the portable terminal in which an abnormal situation occurs is located.

12. The method of claim 10, wherein the collected data is collected from the portable terminal through a gateway.

13. The method of claim 10, wherein the collected data comprises location data or motion sensing data of the portable terminal.

14. A verification server comprises:
a classification type determiner configured to collect non-identifying personal data for a target person and determine a classification type corresponding to each of a plurality of classification criteria for the collected non-identifying personal data; and
a verifier configured to perform verification based on a result of comparing the classification type corresponding to each of the plurality of determined classification criteria with a reference type.
